(19) United States
(12) Patent Application Publication
(10) Pub. No.: US 2011/0302066 A1
(43) Pub. Date: Dec. 8, 2011

(54) Method and system for automated tax appeal

(76) Inventors: Thomas J. Moore, Vorhees, NJ (US); Santo A. Molino, Avalon, NJ (US); Larry R. Levy, Villanova, PA (US); Benjamin Ross Epstein, Forest Hills, NY (US)

(21) Appl. No.: 12/802,208

(22) Filed: Jun. 2, 2010

(51) Int. Cl. G06Q 99/00

(52) U.S. Cl. 705/31

(57) ABSTRACT

A system and method enables users to prepare property and other types of tax appeal forms by an automated template while performing back-end database look-ups and analyses to determine the extent of the appeal. The template can be readily adjusted or added by system administrators to accommodate changes in the tax procedures or newly added jurisdictions, respectively.

### BACKGROUND OF THE INVENTION

1. Field of the Invention

The present invention relates to a method and system for preparing and submitting tax appeal forms; and more particularly to a system and method for receiving property identification information and identifying suitable comparable properties on which an estimate of a correct property assessment can be based.

2. Description of Related Art

Given the considerable fluctuation of real estate property values over the past few decades, home and commercial property owners have questioned with increasing frequency whether the real estate taxes on these properties are fairly levied. In general, annual real estate taxes are computed according to the assessed value of the property, which includes both land and improvements thereon. The fairness of the system is predicated on the assessed value properly reflecting the fair market value of the property and being consistent with the assessment of other properties in the jurisdiction. However, determining a fair market value for a given real property is often difficult, because of the uniqueness of many properties and the relative illiquidity of the market. Whereas the market value of assets such as commodities or shares of the stock of a large corporation are easily, accurately, and regularly established by an active market, values of real property commonly must be determined inferentially.

Although particular governmental structures vary from place to place, property taxation is generally administered by one or more governmental or quasi-governmental entities such as towns; cities; counties; or school, utility, or other like defined governmental districts. For the sake of simplicity, the terms “municipality” and “jurisdiction” are used in the present specification and the subjoined claims to refer to whatever entity is responsible for administering the property tax system, including the property assessment function, and levying the taxes.

To help ensure a fair and equitable taxation system, an appeal process is generally provided, whereby a property owner can contest the assessed property value or the taxes computed therefrom. Incorrect assessments can arise from many sources, including overall fluctuations in the market and incomplete or inaccurate considerations of the specific characteristics of the property, such as location and the age and condition of structures. Of course, human error can also distort the assessment. In principle, the appeal process provides a mechanism for correcting inequities.

Nevertheless, the tax appeal process tends to be quite cumbersome for most property owners. Residential home owners are often daunted by what they perceive as an arcane and impenetrable process. Thus, they often opt not to file the appeal themselves because of the inordinate amount of paperwork and research involved, and instead hire an attorney or other expert to handle the tax appeal on their behalf. However, the expense of hiring an expert is justifiable only if the property owner has a reasonable expectation of a tax reduction that will amortize the expected cost within an acceptable payback period. Commercial property owners face even greater challenges, as the appeal ordinarily requires a higher level of expertise and supporting research.

Thus, there remains a need for a process and system that would simplify the tax appeal process, particularly one which permits a lay person to carry out most, if not all, the tasks needed to prepare the requisite filings that initiate a tax appeal.

### SUMMARY OF THE INVENTION

The method and system described herein assist a residential or commercial property owner in the appeal of property taxes and assessments, by providing a systematic and automated approach for preparing the paperwork necessary for filing the appeal in the relevant venue. Preferably, a database-driven approach is used in the backend processes, whereby the system supports the nuances of any tax jurisdiction according to that jurisdiction's procedures and the specific inputs needed for calculating the property tax amounts. Likewise, as the tax regulations and policies change in a given jurisdiction, the system permits rapid and systematic updating of inputs, tax formulae, and other information to ensure that all appeals comport with current requirements. Finally, the system allows new tax jurisdictions to be added, without necessitating a reprogramming of the underlying computer programming code

Property taxes (also known as real estate taxes) are most commonly computed and levied on an annual basis. Depending on the jurisdiction, the taxes are due either in a single lump sum or in multiple installment payments. In most instances, property taxes go to multiple governmental entities, though the tax may be collected either by a single collecting agency for disbursal to the multiple entities, or in the form of separate payments made directly to the various entities. But in either case, the amounts due are normally based on a common assessed value. Preferably, the present system is programmed to take account of these different collection methodologies to the extent necessary for the appeal process. There is also variation in how frequently each property is assessed. Some jurisdictions assess at regularly scheduled intervals, while others are assessed on other bases, such as any time a given property is sold. The present system and method can account for these variations.

There is further provided a program storage device readable by a processor, tangibly embodying a program of instructions executable by the processor to carry out steps of the present method. Suitable program storage devices include, but are not limited to, magnetic, optical, magnetooptical, semiconductor, and flash memory devices. It will be understood than any memory capable of persistently storing programmed instructions that can be read into the memory of a processor and executed thereby can also be used.

### BRIEF DESCRIPTION OF THE DRAWINGS

The invention will be more fully understood and further advantages will become apparent when reference is had to the following detailed description of the preferred embodiments of the invention and the accompanying drawings, wherein like reference numeral denote similar elements throughout the several views and in which:

FIG. 1 is a flow diagram showing the overall structure of an embodiment of the present method for establishing an automated tax appeal;

FIG. 2 depicts a database structure, which consists of two principal tables;

FIG. 3 shows the architecture of an embodiment of the present system; and

FIG. 4 shows an implementation of a screen for changing administrative parameters in an embodiment of the present system.

### DESCRIPTION OF THE PREFERRED EMBODIMENTS

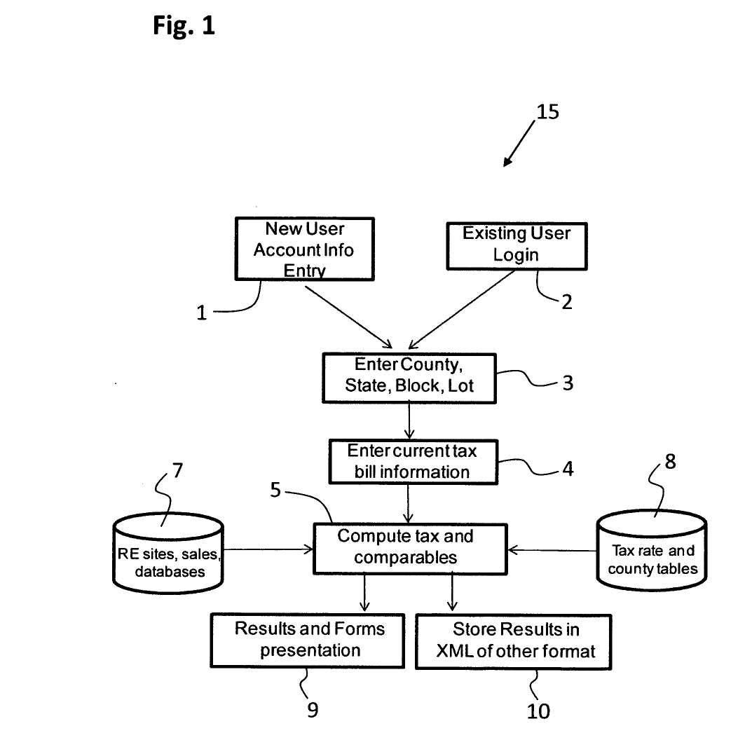

FIG. 1 illustrates generally at 15 the overall data flow in an implementation of the present tax appeal system. For illustrative purposes, the figure is oriented towards the appeal of real estate tax, wherein a user seeks an abatement on the real estate tax assessed by a municipality for a given property. Ordinarily, the system is implemented using a processor that is part of a general purpose computer or server having a program stored in its memory that includes the requisite instructions to carry out the steps of the present method.

To begin, as shown at 1 in FIG. 1, a new user registers with the system by logging in and entering required descriptive information, such as user name and contact information. The system registers the user and stores this information in a suitable database of registered users. Preferably, the system is implemented in a web-based server, with the user employing a general purpose computer or like device that has capability of connecting to the server via a network connection and protocol such as the Internet, though other suitable forms of connection are also usable. Methods for effecting such connections are well known in the art and are here omitted for simplicity of illustration and discussion. Alternatively, the connection is made via a terminal directly connected to a server on which the present system operates.

After establishing the initial registration (1), the same registered user can thereafter log onto the system (2) at will, but without needing to re-enter the user descriptive information. Preferably, the system stores all the information in a machine-readable memory as it is being entered or at least periodically during a user session, so that if a user is interrupted during the data entry process, he/she can log in anew and resume the entry.

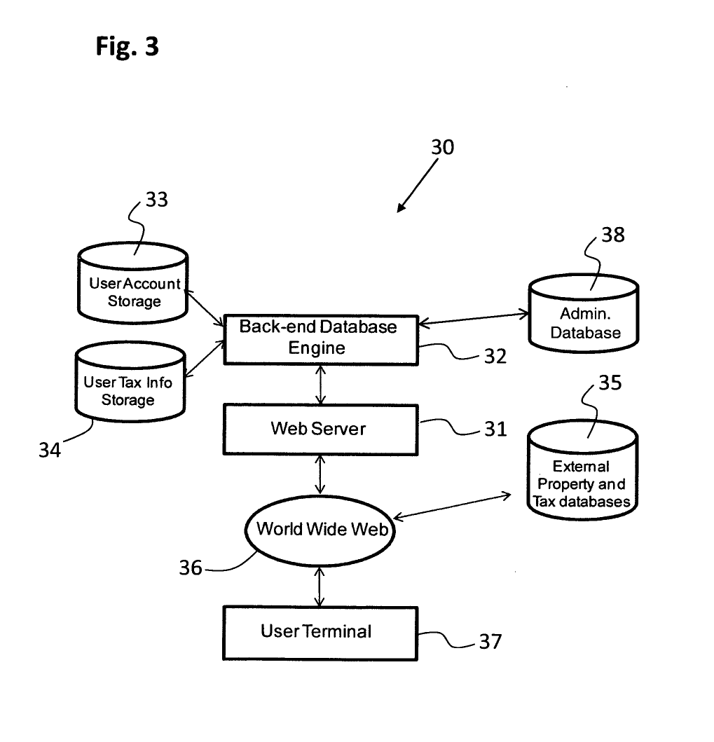

Once the user identification is established and the user is registered and logged into the system, he/she is prompted to enter indicia that uniquely describe the property for which a tax abatement is sought (3). In this specification and the subjoined claims, this property will be referred to as “the subject property.” Typically, a given real property is uniquely specified by the municipality, county, and state in which the property is located, together with other indicia such as a street address or block and lot number. However, different governmental jurisdictions use different descriptive indicia to identify properties. Accordingly, the system preferably includes a database that associates with a given jurisdiction all the indicia required to uniquely specify a given real property, and ascertains whether a property identification entered by a user includes all the required information. The required indicia are preferably included in the administrative database 38 shown in FIG. 3. If any part of the descriptive information is missing, the system preferably prompts the user to complete the information.

In preferred implementations, the system uses database queries as described below to verify that the subject property being entered corresponds with a known property included in the relevant jurisdiction's tax rolls. The database query may also be used to pre-fill the information needed for the operation of the system. If the information is available, the user is relieved of the need to manually enter much or all of the information, and must merely verify its accuracy. This cross-verification improves the reliability of the system and tax appeals prepared therewith.

Thereafter, the user is prompted to enter current tax bill information (4). This information typically includes at least the assessed value of the subject property, the tax rate, and the tax owed. Optionally, the information further includes adjustments or rebates reflecting the status of the owner. For example, military veterans, senior citizens, and disabled persons are sometimes granted partial rebates or tax adjustments. As a further option, information pertaining to the subject property itself is accepted. Such information might include an itemized list of estimated or actual adjustments, if any, to account for property location, improvements, building condition, or other factors that affect the value either positively or negatively. These adjustments may be entered either as an actual dollar amount of the adjustment or as a percentage of the market value. Preferably, the adjustment is limited to a relatively small percentage of value, e.g. a ±5% adjustment.

Using the property identification, tax bill information, and other data thus entered, the system then computes a corrected tax assessment and corresponding tax for the subject property (5). As set forth in more detail below, this computation involves the determination of the assessed values and recent sales data of comparable properties and the corresponding taxes paid by the owners of the comparable properties, as ascertained from various real estate databases, web sites, and governmental records that are either stored locally or accessible through on-line means (7). The databases used may include proprietary sources for which a fee is charged. It is to be understood that for simplicity of illustration, only a single database is shown, but information in most cases is derived from multiple databases. Property tax rates, tax tables, and other information necessary for the corrected tax computation of the subject property are either stored within the system or queried from external databases (typically those operated by the relevant governmental entity having jurisdiction over the subject property) (8). Preferably, the comparables selected have been sold within a recent timeframe e.g., within about one year, so that an accurate and sufficiently current valuation is available from registries maintained by the appropriate governmental entity or a private database that aggregates data from public records, as described above. A correction is optionally applied to account for the overall change in values since a previous sale occurred. Based on the values of these comparable properties and underlying government data parameters, the system computes a corrected assessment and tax for the subject property. The corrected value and tax may then be compared with the corresponding amounts based on the jurisdiction's current assessment and tax for the subject property. If the subject property has a current assessed value that is higher than a computed value derived from the assessed values of the comparable properties, the method then uses this computed assessed value along with the requisite tax tables and/or formulae to compute the approximate property tax that should be owed, given an accurate assessment.

Once data entry is complete and the system has loaded other external information to permit the tax computation to be completed, the system optionally prompts the user for a credit card payment or other type of electronic or non-electronic payment to consummate the transaction and continue with the presentation of the results (this option is not shown in FIG. 1). Of course, payment information might also be collected at any stage of the process, such as when the user initially established an account on the system.

Now provided with all the needed inputs, the system computes the corrected property tax assessment and presents the results to the user, typically as a display on the user's personal computer effected using a conventional browser or as a screen image created via dedicated software (9).

The system further provides the information it has collated in a format suitable for filing a tax appeal in the requisite forum. The results can be delivered electronically as a computer readable file suitable either for on-line filing or ready to be printed in a format that is compliant with the jurisdiction where the tax adjustment is sought. The Adobe PDF format is one preferred file format. Alternatively, a printed copy of the completed appeal form can be provided. Optionally, payment is required only after the display or the formatted tax appeal information is made available. Preferably, the results are stored by the system in any computer-readable memory in any suitable format, such as XML format, for record keeping and later recall (10).

Typically, each jurisdiction has its own format and data required for an appeal filing. Preferably, these requirements are stored in administrative database 38. For example, the filing might need to include an identification of the subject property being appealed by address and/or block and lot number, the property owner(s), and at least a predetermined minimum number of comparables identified by address, market value, and date last sold. Other information that would have to be stored might include the formatting of the petition form, the address of the tax authority of jurisdiction, and the required filing date. In some instances in which a single governmental entity administers and collects taxes for multiple entities (e.g., a municipality, a county, and a school board), the appeal filing must include appropriate reference to each entity. The system is thus enabled to prepare the appeal filing in the required format.

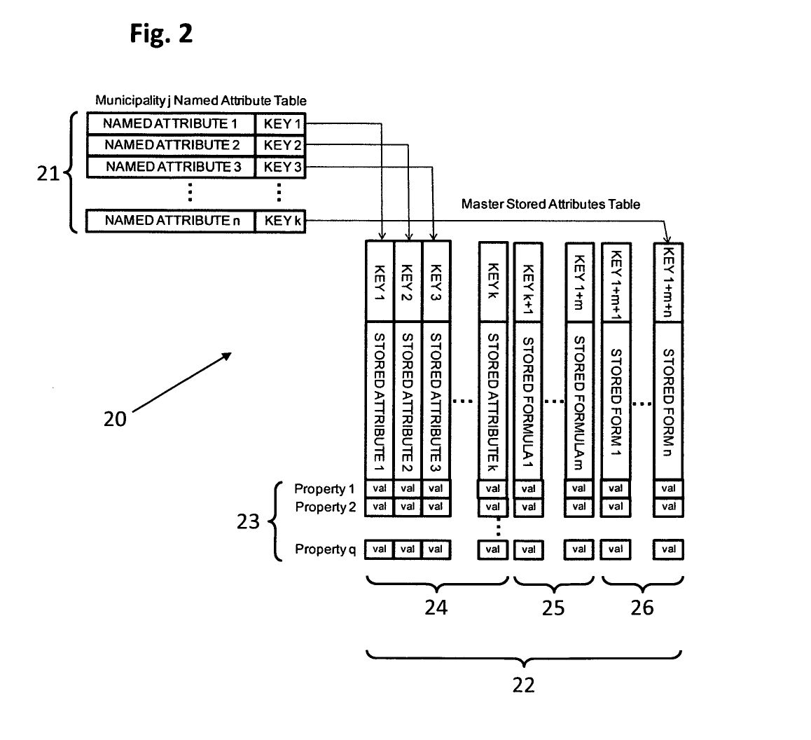

FIG. 2 depicts a form of a database structure 20 useful in the practice of the invention. The database, also indicated as administrative database 38 in FIG. 3, comprises two tables: a Municipality Named Attribute Table 21 and a Master Stored Attributes Table 22. Another table (not shown) enumerates jurisdictions for which the present system is operable and includes identifiers that point to the Named Attributes pertinent for each jurisdiction. Each municipality (tax jurisdiction) has a specific set of Named Attributes that represent the information that is required to identify a property and apply for a property tax adjustment thereon for that jurisdiction. Representative examples of the Named Attributes can include, but are not limited to, indicia such as the subject and comparable property's street and street address number, property city, block number of property, lot number of property, property acreage, property house area, property date of construction, and the minimum/maximum number of comparable properties required for the municipality's petition application. Each Named Attribute is associated with a unique Key Number (designated Key 1 through Key n in Table 21 of FIG. 2. Each Key Number is in turn mapped to a corresponding entry in the Master Stored Attributes Table 22. This second table 22 contains a generic set of attributes 24, thereby allowing more than one Named Attribute to map to a specific generic attribute. Such a mapping allows for the semantic differences and specific nuances of terminology that a given tax jurisdiction may use in their tax forms and tax computation procedures. For example, one jurisdiction might use the term “Block Number” and another “Section Number” in a hierarchical designation of properties.

Table 22 also contains identifying indicia representing specific types of tax computation formulae 25, and identifying indicia representing specific tax forms 26 that present the tax computation results in a jurisdiction-compliant manner. Typically, the information represented by formulae 25 and forms 26 is preloaded into the system and maintained current by a system administrator. Table 22 also contains pointers to the proper forms and formulae to be used for properties in each jurisdiction. Provision is made for expanding the system to add additional jurisdictions and the databases and other information associated with each.

Both the forms and formulae make use of other generic attributes as input parameters. The rows 23 of the database represent the values entered for the stored attributes that are specific to a given subject or comparable property. Additional identifiers map each property to a specific user account (not shown).

Turning now to FIG. 3, there is depicted an implementation 30 of the overall property tax appeal system. In the implementation shown, web server 31 contains the program code capable of handling user interactivity and queries to the Back-end Database Engine 32.

Server 31 is configured to be connected via a computer network, such as the

Internet 36, to one or more user terminals 37. Terminal 37 most commonly is provided by a general purpose or personal computer running an Internet browser, such as Microsoft's Internet Explorer, enabling it to exchange and display documents and information using well-known software protocols and file formats. The network connection may be effected by any suitable means, including wired, wireless, and optical connections. It is to be understood that terminal 37 may also be in the form of an advanced wireless mobile device, smartphone, or other device providing the required network functionalities. Terminal 37 is preferably configured to enable a user to enter information into the system, and to permit receipt and review of information generated by the system.

Back-end Database Engine 32 performs the queries and management of each user's account, including the information that a user has entered to describe one or more subject properties, and any tax computation results about the user's property or properties that the system has already performed. As depicted in FIG. 3, Back-end Database Engine 32 is associated with user account storage 33, which stores the entered user information as described above, and user tax information storage 34, which stores the property identifying indicia and related information, also entered as described above. Although user account storage 33 and user tax information storage 34 are depicted as being separate, all the information contained therein can be stored and managed by a single relational database as known in the art, or stored in an XML or proprietary data format on one or more magnetic, semiconductor, flash, optical, or other like storage devices. The storage may be accomplished locally with storage devices directly connected to the server, or with devices remote to the database engine but communicatively connected thereto (e.g., cloud storage).

Web Server 31 is further configured to access one or more external data resources or databases 35, such as other Web sites and on-line municipal records to obtain assessed values for properties comparable to the subject property entered by the user, or to obtain the official tax rates and tax information for any given property.

An administrative database 38 stores information associating one or more commercial databases or governmental databases that contain tax-related information referenced to specific jurisdictions. This database, which preferably includes references denoted by universal resource locators (URLs) of the type used for Internet communications, directs the program to suitable information sources pertinent to a given property, based on the location descriptors given for the property. Administrative database 38 permits the program to make inquiries with respect to both the subject property and potential comparable properties. Although a single database 35 is shown in FIG. 3 for illustrative purposes, it is to be understood that the requisite tax rates and tax information may reside in plural databases accessible to server 31, preferably via the Internet connectivity afforded by the World Wide Web 36.

In some instances, on-line data in database 35 are available directly from the relevant governmental jurisdiction. Alternatively, commercial third-party services obtain and aggregate relevant information from public records and maintain it in a suitable database. Such services generally facilitate use of their information by providing an Applications Program Interface (API) that can be implemented on the present system. The API is then instructed to query the database to obtain the needed information for each property of interest. The information available may include, but not be limited to, data such as address, block number, lot number, owner name, lot size, living space size, house construction date, date of improvements, outstanding mortgage, purchase date, current tax year assessed value, current tax year property tax invoiced, and other parameters.

Still another approach entails “scraping” of websites containing property data. Commercial and county web sites are often maintained by governmental jurisdictions or real estate data firms to supply data on properties located within a given jurisdiction. Normally such websites are designed to be used by manual requests entered by human users on an occasional basis. However, in the present method, the Web sites would be “scraped;” i.e., the present system would execute code that emulates user-entered queries while scanning the website pages for specific information—in this case assessed value of properties similar to that of the owner.

In addition, some or all of such information may optionally be stored locally in a database maintained in memory associated directly with server 31 and updated as needed.

Preferably, the system is also programmed to generate a message to a system administrator and/or user if attempts to query the various databases fail to produce the required information. The message permits the user to make manual inputs to supply the missing information and alerts the system administrator to update the various databases to remedy any errors or broken URL links, or to add additional databases to remedy incomplete coverage.

In other embodiments (not shown) of the present system and method, server 31 is replaced by a local program that is installed and operated on a user's personal computer. In this case, the program should still have network connectivity to retrieve updated tax information, such as tax rates and procedures for calculating property taxes as well as the External Property and Tax Databases 35. The user login feature ordinarily needed for server-based implementations is optionally omitted if a single user is presumed to use a system of this type. The present method and system may also be implemented using a cloud computing approach.

The computation represented at 5 in FIG. 1 involves first the identification of comparable properties and then the use of the values of these properties to compute a corrected assessed value of the subject property. A number of approaches can be used to identify properties conventionally termed “comparables,” i.e. properties with characteristics such as location, configuration, and condition that are sufficiently similar to those of a subject property to permit a knowledgeable expert to establish a market value for the given property that is commensurate with the market value of the “comparables.” Ordinarily, a comparable is most valuable for a comparison if it has been sold recently in an arms-length transaction, so that the sale price can be regarded as the free market's determination of its fair value.

Preferably, comparable properties are identified and associated tax information is downloaded automatically by operations programmed in the system's processor, operating either in a server as shown in FIG. 3 or in a free-standing user program as described above. Typically, at least three properties are considered necessary to provide a valid basis for comparison, but a computation based on more comparables improves the reliability of the conclusions derived and is thus preferred.

In a possible implementation, a selection universe of properties that are candidates for being used as comparables is identified as follows. A target geographic region is first selected, which may be defined as a geographic region satisfying one or more preselected criteria, such as being within a preselected distance from the subject property, or being within the boundaries of a preselected governmental or quasi-governmental district (e.g. within the same zip code, city, town, or county, or a particular school, utility, or similar district). Within that region, properties which have been sold within a preselected time period and for which a sale price is available are potential candidate comparables. Optionally, the selection universe is further limited by requiring candidate properties to satisfy one or more parameters characterizing the property itself or structures thereon. For example, parameters describing a single-family residence may include, but not be limited to, number of total rooms, number of bedrooms, number of bathrooms, service improvements (e.g., presence of central air conditioning or a swimming pool), property acreage, number of floors, sizes of particular rooms, aggregate square footage, finished basement or attic, assigned school zones, presence and size of garage, age of structure, presence of landscaping, or any other measures known to affect property values. The selection universe might then be restricted to candidate properties satisfying criteria based on some or all of these parameters. In some implementations, the system itself may be programmed to control which criteria are applied, so as to obtain a reasonable number of properties within the selection universe.

Thereafter, some one or more candidate properties within the selection universe are identified to form the basis for the calculation of an assessed value of the subject property.

One possible method of making the final identification involves calculation and use of property comparability scores that measure the degree to which given candidates match the subject property on some or all preselected ones of the foregoing or other useful criteria. It will be understood that some of the parameters are inherently either true or false (e.g., does the property have a swimming pool or central air conditioning?). Other criteria, while numerically specified, are strongly granular, while still others are quantitative and not significantly granular. By a “granular” parameter is meant a value that can assume only a small number of discrete values, such as the number of bedrooms in a house, of which the vast majority have between about 2 and 6. By contrast, other parameters (such as the area of a land parcel or the area of particular rooms in a house) can vary continuously over wide ranges. The similarity score may also include a component based on the geographical distance between a candidate property and the subject property, as nearby properties are generally regarded as providing more reliable data. Properties for which there are recent arm's-length sales may also be weighted more heavily.

In one possible implementation, a set of criteria is selected for making the final selection of candidate properties. For each criterion used, a particular allowable tolerance is preselected. For example, the number of bedrooms of a candidate property might be required to be identical to, or at most one more or less than, that of the property being considered. A match within the tolerance for each criterion is assigned a point value, and the points for all the criteria are summed to yield an overall similarity score for a given candidate property. Optionally, different preselected weightings are applied for different criteria in the summation operation. For example, matching the number of bedrooms might be weighted much more strongly than matching the number of garage spaces in calculating the similarity score.

As mentioned above, ordinarily only those properties that were recently sold can qualify as comparable properties. The sales window typically dates back to nine months from the base date on which the assessment is based.

Once similarity scores are calculated for the properties within the selection universe, a further selection may be carried out to define properties that are to be used in the final comparison. At least two (and preferably three or more) comparables are typically regarded as a necessary basis for a reliable calculation. However, the automated research and calculations possible within present system permit a larger number of comparables to be considered, possibly with different weightings, providing a more reliable calculation. In practice, there is a diminishing benefit to using an excessively large number of comparables, as properties that are either geographically more distant from a subject property or are less similar in character are more marginal as the basis for a comparison. Thus, it is preferred that the number of comparables identified and used in the computation and filing range from about 2 to 5. It is also preferred that the properties selected are those having the highest similarity score. Candidate properties may also be required to have a preselected minimum similarity score to be considered for selection.

In some implementations, the user is offered the option of manually selecting comparables to be used in the calculation and presented in the appeal filing from among those identified automatically by the system.

Once the candidate properties are identified, the system calculates an average assessed property value per square foot of living space and an averaged assessed property value per square foot of property area for the comparables selected. These factors are then applied to the square footage of the living space and the square footage of the property of the subject property to calculate a corrected assessed value for the subject property. The taxes that would be due based on the corrected assessment can then be calculated based on the known “equalization ratio” (sometimes known as the “Director's ratio”) and the tax tables and/or formulae appropriate for the property's tax jurisdiction. As is known in the art, the “equalization ratio” represents a ratio between the actual market value of a property and the market value used to calculate property taxes within a given jurisdiction. For example, the equalization ratio can be used to account for overall average shifts in market value after a jurisdiction-wide reassessment. Some jurisdictions make available their equalization ratios, which the present system obtains as part of its database-querying. If such an official equalization ratio is unavailable, the system can compute one by comparing actual market values (determined from recent sales) of the identified comparables and their present assessments or or taxes paid.

After all of the required computations are complete, the system is configured to prepare the requisite papers for filing a tax appeal, as described above.

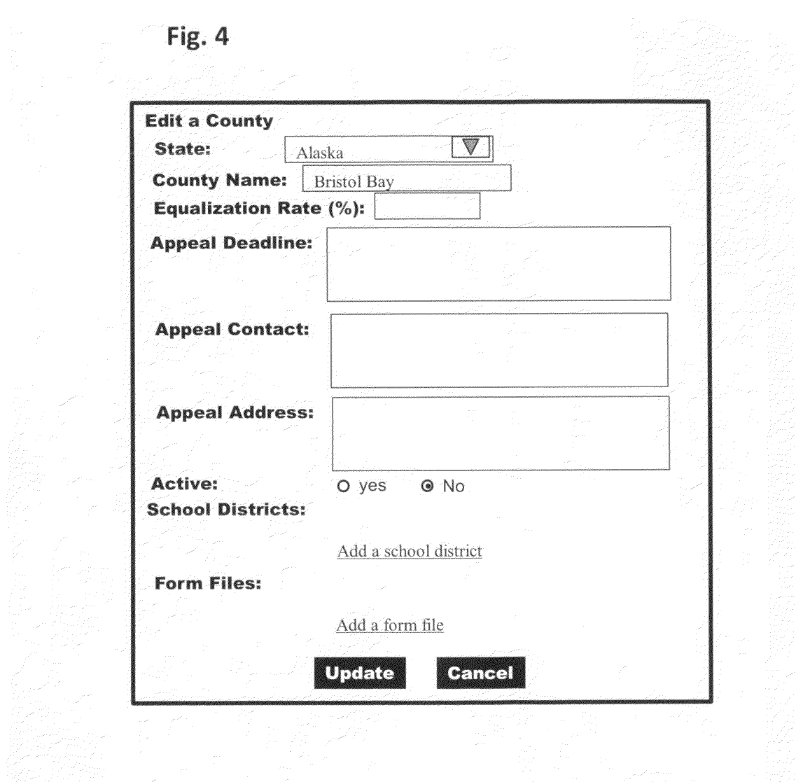

The present system also provides for updating the parameters characterizing a given jurisdiction's taxation and appeal processes. FIG. 4 provides a screen shot of an Administrator's screen that facilitates the modification or updating of the information requested by a given tax jurisdiction. This screen contains generic fields commonly required or displayed by the tax authorities in a compliant tax appeal application form. Such forms allow for easy adaptation of the information displayed on the form and on the screen during a user's session for an appeal to a given jurisdiction. Information entered through this screen is used to update corresponding entries in administrative database 38.

It is to be understood that the present invention may be implemented in various forms of hardware, software, firmware, special purpose processors, or a combination thereof. In some embodiments, the present invention may be implemented in software as an application program tangibly embodied on a program storage device. The application program may be uploaded to, and executed by, a machine comprising any suitable architecture. The various processes and functions described herein may either be part of the micro instruction code or part of the application program (or a combination thereof) which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

Having thus described the invention in rather full detail, it will be understood that such detail need not be strictly adhered to, but that additional changes and modifications may suggest themselves to one skilled in the art. It is to be understood that the present system and process may be implemented in various ways, using different equipment and carrying out the steps described herein in different orders. For example, in addition to the web server and individual user implementations described above, the present method system might also be implemented in a cloud computing context. All of these changes and modifications are to be understood as falling within the scope of the invention as defined by the subjoined claims.

What is claimed is:

1. A system for preparing for a user an appeal of a property tax assessment of a subject real property situated in a tax jurisdiction, comprising:
a processor and processor memory operably connected thereto, the processor being programmed to:
(a) receive entry of indicia that uniquely identify the subject property;
(b) receive entry of information that describes the subject property and improvements thereof;
(c) receive entry of current tax bill information pertaining to the subject property, including at least a current assessed value of the subject property;
(d) select comparable properties on which to base a calculation of a corrected property value of the subject property commensurate with values of the comparable properties;
(e) calculate the corrected property value and the tax corresponding thereto;
(f) report to the user the corrected property value and the corresponding tax;
(g) create a tax appeal document suitable for filing in the tax jurisdiction an appeal of the current assessed value of the subject property and the taxes commensurate with the current assessed value.

2. A system as recited by claim 1, further comprising a network connection through which the processor is programmed to access one or more external, on-line databases.

3. A system as recited by claim 1, further comprising a network connection through which the processor is programmed to connect to a user terminal.

4. A system as recited by claim 3, wherein the processor is further programmed to accept initial registration from a user employing the user terminal to communicate with the processor, the registration comprising receipt and storage of user identifying information in the processor memory; and thereafter to accept future logins by the user, and wherein the subject property is associated with the user.

5. A system as recited by claim 4, wherein the processor is programmed so as to accept entry by the user through the user terminal of the indicia that uniquely identify the subject property, the information that describes the subject property and improvements thereof, and the current tax bill information pertaining to the subject property.

6. A system as recited by claim 1, further comprising an administrative database wherein are stored a plurality of municipality/named attributes tables, a master stored attributes table, and a plurality of stored properties, and wherein:
each of the municipality/named attributes tables is associated with a particular jurisdiction and includes a plurality of named attributes;
the master stored attributes table comprises a plurality of stored attributes, a plurality of stored formulae, and a plurality of stored forms,
each named attribute of each of the municipality/named attributes tables being associated with exactly one of the stored attributes;
at least one of the stored formulae and at least one of the stored forms being associated with each the jurisdiction, and
values of the stored attributes being stored for each of the stored properties.

7. A system as recited by claim 1, wherein the selection of the comparable properties comprises identification of candidate comparables, from which the comparable properties are chosen.

8. A system as recited by claim 7, wherein the number of comparables selected ranges from 2 to 5.

9. A system as recited by claim 7, wherein a similarity score is calculated for each of the candidate comparables and the selection of the comparables is based on the calculated similarity score.

10. A system as recited by claim 9, wherein a preselected number of comparables are selected from among the candidate comparables, the comparables selected being those having the highest similarity scores.

11. A system as recited by claim 9, wherein all candidate comparables having a similarity score greater than a preselected value are selected as comparables.

12. A system as recited by claim 1, wherein the calculation of the corrected property value is based on a calculation of a computed average value per square foot of land area and a computed average value per square foot of improvement area of the comparable properties.

13. A method of preparing for a user an appeal of a property tax assessment of a subject real property situated in a tax jurisdiction, comprising the steps of:
(a) providing a processor and processor memory operably connected thereto,
(b) receiving entry of indicia that uniquely identify the subject property;
(c) receiving entry of information that describes the subject property and improvements thereof;
(d) receiving entry of current tax bill information pertaining to the subject property, including at least a current assessed property value;
(e) selecting comparable properties on which to base a calculation of a corrected property value of the subject property commensurate with values of the comparable properties;
(f) calculating the corrected property value of the subject property and the tax corresponding to the corrected property value;
(g) reporting to the user the corrected property value and the corresponding tax;
(h) creating a tax appeal document suitable for filing in the tax jurisdiction an appeal of the current assessed value of the subject property and the taxes commensurate with the current assessed value,
steps (b) through (h) being carried out by the processor in accordance with instructions programmed and stored in the processor memory.

14. A method as recited by claim 13, further comprising the step of accepting initial registration from a user employing a user terminal to communicate with the processor, the registration comprising receipt and storage of user identifying information in the processor memory; and thereafter to accept future logins by the user, and wherein the subject property is associated with the user.

15. A method as recited by claim 13, wherein the processor is connected to a network connection permitting the processor to access one or more external, on-line databases.

16. A method as recited by claim 13, wherein is stored in the processor memory an administrative database comprising a plurality of municipality/named attributes tables, a master stored attributes table, and a plurality of stored properties, and wherein:
each of the municipality/named attributes tables is associated with a particular jurisdiction and includes a plurality of named attributes;
the master stored attributes table comprises a plurality of stored attributes, a plurality of stored formulae, and a plurality of stored forms,
each named attribute of each of the municipality/named attributes tables being associated with exactly one of the stored attributes;
at least one of the stored formulae and at least one of the stored forms being associated with each the jurisdiction, and
values of the stored attributes being stored for each of the stored properties.

17. A method as recited by claim 16, wherein the processor is programmed to accept updates of entries in the administrative database entered by an authorized system administrator.

18. A method as recited by claim 16, wherein the processor is programmed to accept entry by an authorized system administrator of additional jurisdictions, and municipality/named attributes tables, and stored attributes, formulae, and forms associated therewith.

19. A method as recited by claim 13, wherein the processor is programmed to accept entry of information required to accomplish steps (b) through (d) that is provided by the user through the user terminal.

20. A method as recited by claim 13, wherein the selecting step comprises identifying candidate comparables and choosing comparable properties from among the candidate comparables.

21. A method as recited by claim 20, wherein the selecting step further comprises calculating a similarity score for each of the candidate comparables and basing the selecting on the calculated similarity scores.

22. A method as recited by claim 20, wherein the selecting comprises choice of a preselected number of comparables having the highest similarity scores.

23. A method as recited by claim 20, wherein all candidate comparables having a similarity score greater than a preselected value are selected as comparables.

24. A method as recited by claim 13, wherein the calculation of the corrected property value is based on a calculation of a computed average value per square foot of land area and a computed average value per square foot of improvement area of the comparable properties.

25. A program storage device readable by a processor, tangibly embodying a program of instructions executable by the processor to carry out a method comprising the steps of:
(a) receiving entry of indicia that uniquely identify the subject property;
(b) receiving entry of information that describes the subject property and improvements thereof;
(c) receiving entry of current tax bill information pertaining to the subject property, including at least a current assessed property value;
(d) selecting comparable properties on which to base a calculation of a corrected property value of the subject property commensurate with values of the comparable properties;
(e) calculating the corrected property value of the subject property and the tax corresponding to the corrected property value;
(f) reporting to the user the corrected property value and the corresponding tax;
(g) creating a tax appeal document suitable for filing in the tax jurisdiction an appeal of the current assessed value of the subject property and the taxes commensurate with the current assessed value.
